(19) United States
(12) Patent Application Publication
(10) Pub. No.: US 2025/0045113 A1
(43) Pub. Date: Feb. 6, 2025

(54) SYSTEMS AND METHODS OF OPTIMIZING COMPUTE TASKS

(71) Applicant: Mercedes-Benz Group AG, Stuttgart (DE)

(72) Inventors: Francois PIEDNOEL, Sunnyvale, CA (US); Skylar STEIN, Sunnyvale, CA (US)

(21) Appl. No.: 18/229,947

(22) Filed: Aug. 3, 2023

(51) Int. Cl. G06F 9/50

(52) U.S. Cl. CPC G06F 9/5038

(57) ABSTRACT

A computing system can execute a heuristic technique (e.g., traveling salesman algorithm) and/or a learning-based technique to determine an optimal distribution of compute tasks for execution on a given hardware topology.

### BACKGROUND

Universal Chiplet Interconnect Express (UCIe) provides an open specification for an interconnect and serial bus between chiplets, which enables the production of large system-on-chip (SoC) packages with intermixed components from different silicon manufacturers. It is contemplated that autonomous vehicle computing systems may operate using chiplet arrangements that follow the UCIe specification. One goal of creating such computing systems is to achieve the robust safety integrity levels of other important electrical and electronic (E/E) automotive components of the vehicle.

### SUMMARY

A computing system for optimizing compute tasks for execution on a particular hardware topology is described herein. In various examples, the computing system can determine a set of weighted parameters for a given hardware topology, and (i) determine an optimal distribution of runnables of a compute graph on the given hardware topology, and (ii) optimize data positioning in memory components to facilitate execution of the runnables by specified processing components of the given hardware topology based on the set of weighted parameters. In various implementations described herein, the set of weighted parameters for the given hardware topology can include computer and/or network latency, bandwidth, memory, power usage, computing power, compute units, hardware age, hardware wearing, and/or thermal cooling. Upon determining the optimal distribution of runnables, the computing system may then configure a scheduling program on the given hardware topology to execute the compute graph in accordance with the optimal distribution.

In various implementations, the computing system can determine the optimal distribution through execution of a traveling salesman algorithm using the set of weighted parameters and a set of requirements of the runnables. In certain embodiments, the given hardware topology can correspond to a system-on-chip (SoC) comprising a central chiplet and a set of workload processing chiplets, or a multiple system-on-chip (mSoC) that includes a plurality SoCs combined to execute the compute tasks. In such arrangements, the central chiplet of each SoC can include a shared memory accessible by the set of workload processing chiplets, and the scheduling program to schedule the runnables of the compute graph for execution by the workload processing chiplets in accordance with the optimal distribution. In further implementations, the shared memory can store data required for executing the runnables and can include a hierarchy comprising a set of caches accessible over a network, which are associated with intrinsic latencies.

In certain examples, the computing system can reevaluate the optimal distribution of the runnables on the given hardware topology. For example, the computing system can determine an updated set of weighted parameters for the given hardware topology and/or determine an updated set of requirements of the runnables. Based on reevaluating the optimal distribution, the computing system can determine an updated optimal distribution of the runnables on the given hardware topology, and reconfigure the scheduling program to execute the compute graph in accordance with the updated optimal distribution. As provided herein, the computing system can comprise a backend system that performs the techniques described herein on computer servers. In variations, the computing system can be included in the given hardware topology (e.g., the SoC or mSoC) such that the optimization of the compute tasks are performed on the same computing system that executes the compute tasks.

In some embodiments, a method of optimizing compute tasks of a software structure is provided herein. The method can be executed by a computing system and can include repeatedly distributing the software structure comprising the compute tasks onto a hardware topology comprising a set of computing components (e.g., the components of an SoC or mSoC). For example, the method can be executed using a learning-based approach, such as through implementation of a neural network, machine learning (ML) model, or artificial intelligence technique. Based on repeatedly distributing the software structure on the hardware topology, the computing system can determine an optimal arrangement for executing the compute tasks of the software structure on the set of computing components of the hardware topology.

For each iteration of repeatedly distributing the software structure on the hardware topology, the computing system can simulate execution of the compute tasks for the iteration. The system can further measure the results of simulating the execution of the compute tasks for each iteration, where the results can correspond to one or more of bandwidth usage across the hardware topology, latency, memory usage, power consumption, and the like. Upon converging on the most optimal arrangement, the system can cause or otherwise facilitate the set of computing components to execute the compute tasks of the software structure on the set of computing components of the hardware topology in accordance with the optimal arrangement.

### BRIEF DESCRIPTION OF THE DRAWINGS

The disclosure herein is illustrated by way of example, and not by way of limitation, in the figures of the accompanying drawings in which like reference numerals refer to similar elements, and in which:

FIG. 1 is a block diagram depicting an example computing system in which embodiments described herein may be implemented, in accordance with examples described herein;

FIG. 2 is a block diagram depicting an example computing system implementing specialized modules for optimizing compute tasks given a hardware topology, according to examples described herein;

FIG. 3 is a block diagram depicting a system-on-chip (SoC) in which examples described herein may be implemented, in accordance with examples described herein;

FIG. 4 is a block diagram illustrating an example central chiplet of an SoC arrangement for executing workloads in independent pipelines, in accordance with examples described herein;

FIG. 5 is a block diagram depicting an example multiple system-on-chip (mSoC), in accordance with examples described herein; and

FIGS. 6 and 7 are a flow charts describing example methods of optimizing compute tasks for a given hardware topology, according to examples described herein.

### DETAILED DESCRIPTION

A system on chip (SoC) can comprise an integrated circuit that combines multiple components of a computer or electronic system onto a single chip, providing a compact and efficient solution for a wide range of applications. The main advantage of an SoC is its compactness and reduced complexity, since all the components are integrated onto a single chip. This reduces the need for additional circuit boards and other components, which can save space, reduce power consumption, and reduce overall cost. The components of an SoC are often referred to as chiplets, which are small, self-contained semiconductor components that can be combined with other chiplets to form the SoC.

Chiplets are designed to be highly modular and scalable, allowing for the creation of complex systems from smaller, simpler components and are typically designed to perform specific functions or tasks, such as memory, graphics processing, or input/output (I/O) functions. They may be interconnected with each other and with a main processor or controller using high-speed interfaces. Chiplets offer increased modularity, scalability, and manufacturing efficiency compared to traditional monolithic chip designs, as well as the ability to be tested individually before being combined into the larger system.

In accordance with examples described herein, a computer hardware topology (e.g., comprising a set of chiplets arranged on an SoC or mSoC) can be tasked with executing workloads. In certain implementations, the workloads can be executed as runnables to perform autonomous driving tasks, such as general perception, scene understanding, object detection and classification, ML inference, motion prediction and planning, and/or autonomous vehicle control tasks. In various aspects, the computing system can comprise an SoC or multiple-SoC arrangement, with each SoC comprising multiple chiplets for performing the autonomous driving tasks. Accordingly, the hardware topology can comprise the central chiplet of the SoC, one or more sensor data input chiplets, any number of workload processing chiplets, ML accelerator chiplets, general compute chiplets, autonomous drive chiplets, high-bandwidth memory chiplets, and interconnects between the chiplets.

In certain examples, the sensor data input chiplet obtains sensor data from the vehicle sensor system, which can include any combination of cameras, LIDAR sensors, radar sensors, ultrasonic sensors, proximity sensors, and the like. The central chiplet can comprise the shared memory and reservation table where information corresponding to workloads (e.g., workload entries) are inputted. In further examples, the set of workload processing chiplets can execute workloads as runnables using dynamic scheduling and the reservation table implemented in the shared memory of each SoC.

Upon obtaining each item of sensor data (e.g., individual images, point clouds, radar pulses, etc.), the sensor data input chiplet can indicate availability of the sensor data in the reservation table, store the sensor data in a cache, and indicate the address of the sensor data in the cache. Through execution of workloads in accordance with a set of independent pipelines, a set of workload processing chiplets can monitor the reservation table for available workloads. As provided herein, the initial raw sensor data can be referenced in the reservation table and processed through execution by an initial set of workloads by the workload processing chiplets. As an example, this initial processing can comprise stitching images to create a 360-degree sensor view of the vehicle's surrounding environment, which can enable the chiplets to perform additional workloads on the sensor view (e.g., object detection and classification tasks).

When workloads are completed by the chiplets, dependency information for additional workloads in the reservation table can be updated to indicate so, and the additional workloads can become available for execution in the reservation table when no dependencies exist. In certain examples, the chiplets can monitor the reservation table by way of a workload window and instruction pointer arrangement, in which each entry of the reservation table is sequentially analyzed along the workload window by the workload processing chiplets. If a particular workload is ready for execution (e.g., all dependencies are resolved), the workload processing chiplets can execute the workload accordingly.

The execution of the workloads can be governed by a compute graph of a software structure that determines when dependencies for particular workloads are satisfied and when those workloads can be executed accordingly. In accordance with examples described herein, the scheduling and allocation of workloads on the given set of hardware components can be optimized (e.g., to maximize data locality and minimize latency), and the scheduling program (e.g., on the central chiplet) can be configured based on the optimization.

In certain implementations, the computing system can perform one or more functions described herein using a learning-based approach, such as by executing an artificial neural network (e.g., a recurrent neural network, convolutional neural network, etc.) or one or more machine-learning models. Such learning-based approaches can further correspond to the computing system storing or including one or more machine-learned models. In an embodiment, the machine-learned models may include an unsupervised learning model. In an embodiment, the machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

As provided herein, a “network” or “one or more networks” can comprise any type of network or combination of networks that allows for communication between devices. In an embodiment, the network may include one or more of a local area network, wide area network, the Internet, secure network, cellular network, mesh network, peer-to-peer communication link or some combination thereof and may include any number of wired or wireless links. Communication over the network(s) may be accomplished, for instance, via a network interface using any type of protocol, protection scheme, encoding, format, packaging, etc.

One or more examples described herein provide that methods, techniques, and actions performed by a computing device are performed programmatically, or as a computer implemented method. Programmatically, as used herein, means through the use of code or computer-executable instructions. These instructions can be stored in one or more memory resources of the computing device. A programmatically performed step may or may not be automatic.

One or more examples described herein can be implemented using programmatic modules, engines, or components. A programmatic module, engine, or component can include a program, a sub-routine, a portion of a program, or a software component or a hardware component capable of performing one or more stated tasks or functions. As used herein, a module or component can exist on a hardware component independently of other modules or components. Alternatively, a module or component can be a shared element or process of other modules, programs or machines.

Some examples described herein can generally require the use of computing devices, including processing and memory resources. For example, one or more examples described herein may be implemented, in whole or in part, on computing devices such as servers and/or personal computers using network equipment (e.g., routers). Memory, processing, and network resources may all be used in connection with the establishment, use, or performance of any example described herein (including with the performance of any method or with the implementation of any system).

Furthermore, one or more examples described herein may be implemented through the use of instructions that are executable by one or more processors. These instructions may be carried on a non-transitory computer-readable medium. Machines shown or described with figures below provide examples of processing resources and computer-readable mediums on which instructions for implementing examples disclosed herein can be carried and/or executed. In particular, the numerous machines shown with examples of the invention include processors and various forms of memory for holding data and instructions. Examples of non-transitory computer-readable mediums include permanent memory storage devices, such as hard drives on personal computers or servers. Other examples of computer storage mediums include portable storage units, such as flash memory or magnetic memory. Computers, terminals, network-enabled devices are all examples of machines and devices that utilize processors, memory, and instructions stored on computer-readable mediums. Additionally, examples may be implemented in the form of computer programs, or a computer usable carrier medium capable of carrying such a program.

### Example Computing System

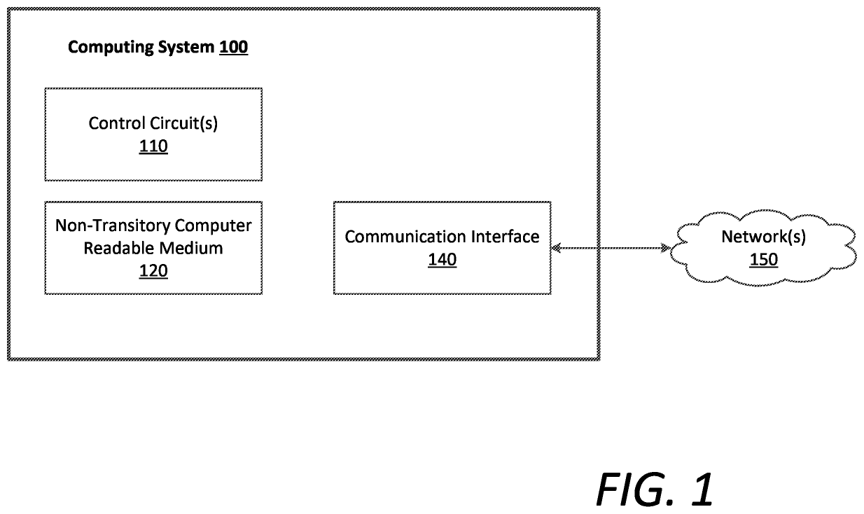

FIG. 1 is a block diagram depicting an example computing system 100 in which embodiments described herein may be implemented, in accordance with examples described herein. In an embodiment, the computing system 100 can include one or more control circuits 110 that may include one or more processors (e.g., microprocessors), one or more processing cores, a programmable logic circuit (PLC) or a programmable logic/gate array (PLA/PGA), a field programmable gate array (FPGA), an application specific integrated circuit (ASIC), systems on chip (SoCs), or any other control circuit. In some implementations, the control circuit(s) 110 and/or computing system 100 may be part of, or may form, a vehicle control unit (also referred to as a vehicle controller) that is embedded or otherwise disposed in a vehicle (e.g., a Mercedes-Benz® car, truck, or van). For example, the vehicle controller may be or may include an infotainment system controller (e.g., an infotainment head-unit), a telematics control unit (TCU), an electronic control unit (ECU), a central powertrain controller (CPC), a central exterior & interior controller (CEIC), a zone controller, an autonomous vehicle control system, or any other controller (the term “or” is used herein interchangeably with “and/or”).

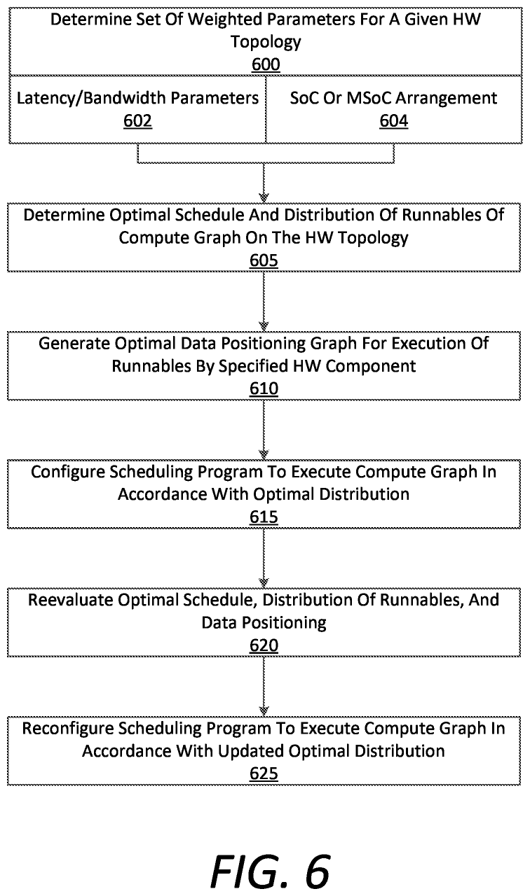

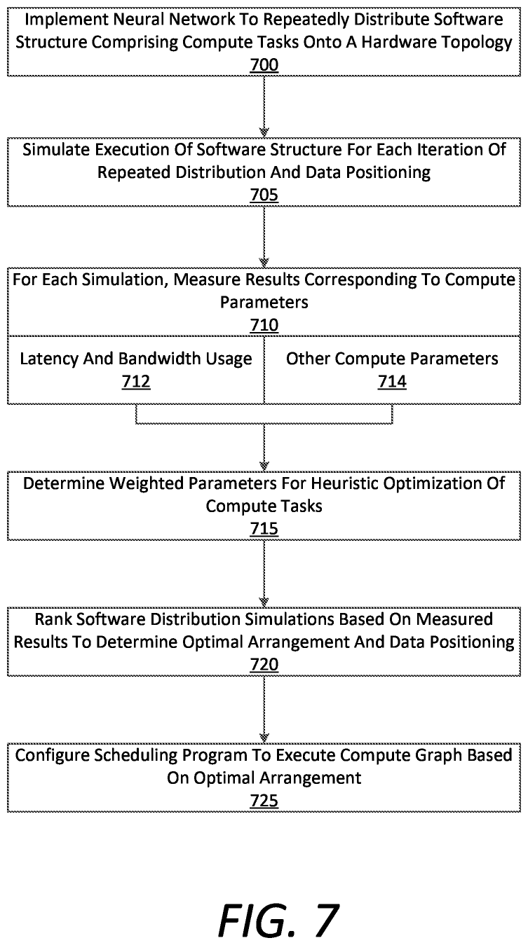

In an embodiment, the control circuit(s) 110 may be programmed by one or more computer-readable or computer-executable instructions stored on the non-transitory computer-readable medium 120. The non-transitory computer-readable medium 120 may be a memory device, also referred to as a data storage device, which may include an electronic storage device, a magnetic storage device, an optical storage device, an electromagnetic storage device, a semiconductor storage device, or any suitable combination thereof. The non-transitory computer-readable medium 120 may form, for example, a computer diskette, a hard disk drive (HDD), a solid state drive (SDD) or solid state integrated memory, a random access memory (RAM), a read-only memory (ROM), an erasable programmable read-only memory (EPROM or Flash memory), a static random access memory (SRAM), dynamic random access memory (DRAM), a portable compact disc read-only memory (CD-ROM), a digital versatile disk (DVD), and/or a memory stick. In some cases, the non-transitory computer-readable medium 120 may store computer-executable instructions or computer-readable instructions, such as instructions to perform the below methods described in connection with FIGS. 6 and 7.

In various embodiments, the terms “computer-readable instructions” and “computer-executable instructions” are used to describe software instructions or computer code configured to carry out various tasks and operations. In various embodiments, if the computer-readable or computer-executable instructions form modules, the term “module” refers broadly to a collection of software instructions or code configured to cause the control circuit 110 to perform one or more functional tasks. The modules and computer-readable/executable instructions may be described as performing various operations or tasks when the control circuit(s) 110 or other hardware components execute the modules or computer-readable instructions.

In further embodiments, the computing system 100 can include a communication interface 140 that enables communications over one or more networks 150 to transmit and receive data. In various examples, the computing system 100 can communicate, over the one or more networks 150, with fleet vehicles using the communication interface 140 to receive sensor data and implement the methods described throughout the present disclosure. In certain embodiments, the communication interface 140 may be used to communicate with one or more other systems. The communication interface 140 may include any circuits, components, software, etc. for communicating via one or more networks 150 (e.g., a local area network, wide area network, the Internet, secure network, cellular network, mesh network, and/or peer-to-peer communication link). In some implementations, the communication interface 140 may include for example, one or more of a communications controller, receiver, transceiver, transmitter, port, conductors, software and/or hardware for communicating data/information.

As an example embodiment, the computing system 100 can be comprised in one or more backend computer servers (e.g., in a server farm or data center facility), and can perform the compute task allocation and optimization techniques described herein for one or more computing applications, such as for autonomous drive computing systems located on-board autonomous vehicles. These autonomous drive computing systems can comprise one or more SoCs that include a fixed hardware arrangement of chiplets, hierarchical caches, and interconnects that are defined by a particular specification (e.g., UCIe).

In another embodiment, the control circuit(s) 110 of the computing system 100 can be included in the SoC arrangement(s), in which the computing system 100 performs a self-optimization for compute tasks configured to be executed by the SoCs. In various examples, each SoC can include a set of chiplets, including a central chiplet comprising a shared memory in which a reservation table is utilized to execute various autonomous driving workloads as runnables in independent pipelines, as described herein.

### System Description

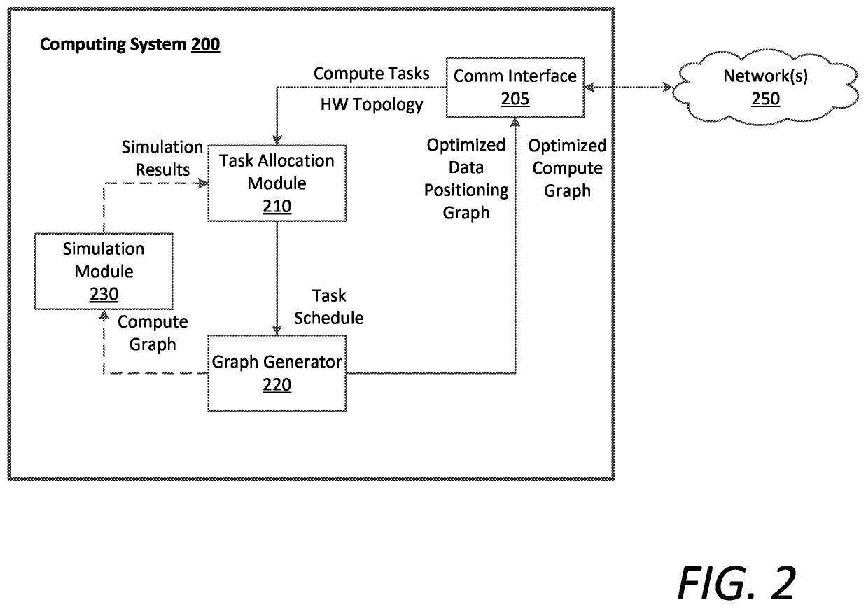

FIG. 2 is a block diagram depicting an example computing system 200 implementing specialized modules for optimizing compute tasks given a hardware topology, according to examples described herein. As provided herein, the computing system 200 shown and described with respect to FIG. 2 may be implemented as a backend computing system, front-end computing system (e.g., an on-board computing system of a vehicle), or a combination of both, and can correspond to one or more embodiments of the computing system 100 as shown and described with respect to FIG. 1.

Referring to FIG. 2, the computing system 200 can include a communication interface 205 that enables the computing system 200 to communicate over one or more networks 250. For backend computing system embodiments, the communication interface 205 can receive a particular description of (i) a hardware topology comprising an arrangement of computer components (e.g., one or more SoCs), and (ii) a software structure comprising a set of compute tasks that correspond to workloads or runnables. In various examples described herein, the compute tasks can correspond to autonomous driving tasks.

The computing system 200 can include a task allocation module 210 that can generate an optimal task schedule using a learning-based approach or heuristically through optimization of a set of weighted parameters. For example, the hardware components of an SoC or mSoC arrangement and their interconnects can include limitations on a set of weighted parameters, such as maximum constraints for latency, bandwidth, memory, power usage, computing power, thermal cooling, security, robustness, etc. In further embodiments, one or more weighted parameters may be identified through learning-based simulation (described below), and can further include individual latency, compute unit, bandwidth, thermal values, etc. for individual components of the hardware topology (e.g., ML accelerators, autonomous drive chiplet, high-bandwidth memory chiplets, interconnects, etc.) For illustration, a network path for transmitting data between two or more cores in the SoC can pass through data and/or execution caches (level one caches), one or more level two caches associated with each core, a shared cache (level three cache), a set of network interface units (NIUs), and/or a set of UCIe interconnects. Each of these components and/or the connections between the components may have constraints on latency, bandwidth, memory size, computing power, and the like.

In various embodiments, the task allocation module 210 can utilize a heuristic technique (e.g., a traveling salesman algorithm) using weighted parameters of the hardware topology (e.g., latency, bandwidth, memory size, computing power, etc.) to determine a most optimal distribution of the software structure for execution on the individual hardware components of the hardware topology. As provided herein, the software structure can be arranged as a set of compute tasks in a compute graph comprising various runnables (nodes in the graph) that may be interconnected based on the necessary interactions between the runnables. For example, a first runnable can involve the detection of external dynamic entities (e.g., pedestrians, other vehicles, bicyclists, etc.) within proximity of the vehicle. A second runnable can involve predicting the motion of each external dynamic entity. Accordingly, the second runnable receives, as input, the output of the first runnable, and therefore these runnables include a connection within the initial compute graph.

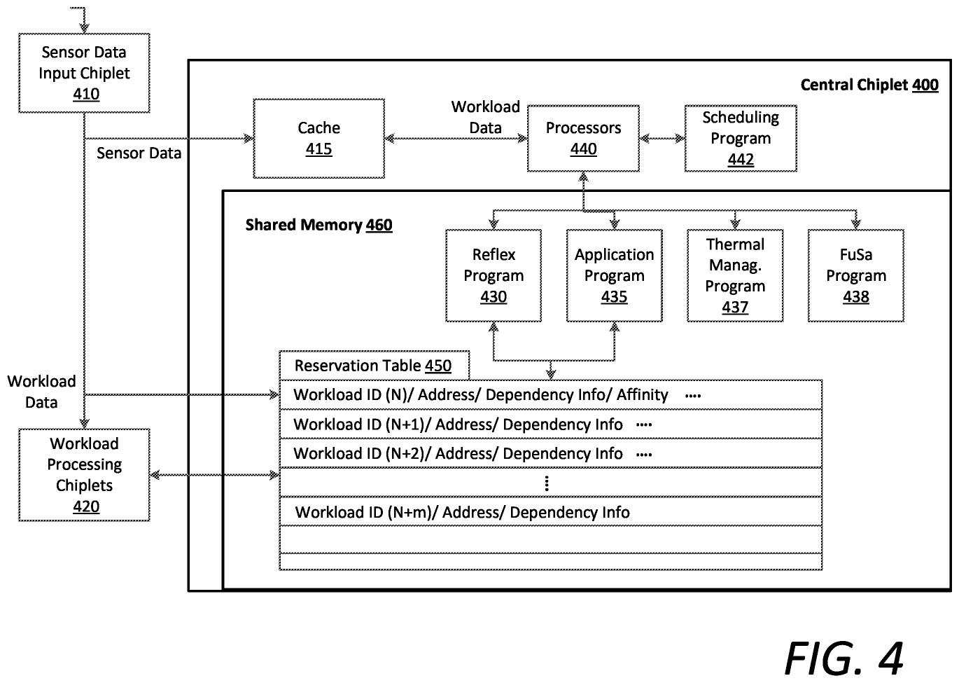

As further provided herein, a compute graph can identify which particular hardware components are to execute each particular compute task of the software structure, and can be modified using a scheduling program and workload reservation table, as described in detail in FIG. 4. Furthermore, in example described herein, the task allocation module 210 and graph generator 220 shown with respect to FIG. 2 can output an optimized compute graph as well as an optimized data positioning graph, which identifies the data location (e.g., in a specified memory, solid state drive, high-bandwidth memory, cache, mailbox, etc.) of where specific data elements are to be stored and accessed by specified hardware components. As such, the optimization of compute tasks performed by the task allocation module 210 and graph generator 220 given a hardware topology can result in affinity schedule, in which specified compute tasks are allocated to specified processing units.

Execution of the heuristic method (e.g., the traveling salesman algorithm) by the task allocation module 210, given the weighted constraints of the hardware topology and the requirements of the various runnables and their connections in the compute graph, can result in a task schedule that can be processed by a graph generator 220 of the computing system 200 to generate an optimized data positioning graph and an optimized compute graph executable by the hardware components of the hardware topology. As provided herein, the optimized data positioning graph maximizes data locality for the hardware components in accessing the data required for executing their assigned runnables. In various examples, the optimized compute graph can provide a most optimal solution for (i) allocating runnables to specified hardware components, and (ii) scheduling the execution of the runnables on the specified hardware components. Especially, execution of a traveling salesman algorithm by the task allocation module 210 can facilitate in the graph generator 220 producing an optimized compute graph and optimized data positioning graph geared towards minimizing network latency, power consumption, and/or memory usage within the hardware topology.

Upon converging on the best-fit and most optimal solution, the task schedule and optimized compute graph outputs of the task allocation module 210 and graph generator 220 can be utilized to allocate and schedule the runnables. In the context of an SoC hardware arrangement, a mailbox and/or reservation table implemented on a central chiplet that includes a shared memory accessible by other workload processing chiplets, can allocate and schedule the runnables (e.g., in a reservation table) in accordance with the optimized compute graph, and position raw or processed data in accordance with the optimized data positioning graph.

It is contemplated that the various connections between runnables in the optimized compute graph can be associated with a safety rating (e.g., an ASIL rating) that can dictate the importance or safety requirement of the communications between the runnables. For example, a connection between two runnables having an ASIL-D rating can be prioritized over a connection between two runnables having an ASIL-B rating. In such examples, the weighted parameters for optimizing the compute graph and data positioning graph can include the safety ratings of the connections between runnables in the compute graphs.

In further examples, the computing system 200 can reevaluate the execution of the runnables in the optimized manner as outputted via the heuristic technique. For example, over time, certain computing components may experience wear or natural degradation. Additionally, over-the-air software updates can add or reduce software constraints, such as bandwidth requirements, memory usage, latency limits, etc. As such, the task allocation module 210 and graph generator 220 can reevaluate the compute tasks and the hardware topology to determine whether a more optimized solution exists. In certain implementations, the central chiplet can periodically or dynamically perform the heuristic optimization (e.g., given the wear and/or updated software requirements). If a more optimal solution is determined, the task allocation module 210 and graph generator 220 can generate updated task schedules and compute graphs respectively based on the updated information from the hardware topology and/or compute tasks.

In alternative embodiments, the task allocation module 210 and graph generator 220 can be implemented in a learning-based approach, such as a neural network utilizing machine learning (ML) trained to determine an optimal fit for compute tasks of a software structure on a given hardware topology (e.g., without weighted parameters, or to identify weighted parameters for the heuristic approach). In such embodiments, the computing system 200 can allocate compute tasks to specified hardware component(s) for execution, and ultimately configure an optimized data positioning graph and optimized schedule for executing the cumulative set of compute tasks on the hardware components. In such an approach, the task allocation module 210 and graph generator 220 can iteratively “distribute” the software structure (comprising the set of compute tasks) and position raw and processed data onto the hardware topology arbitrarily and determine a performance result of the distribution.

For each iteration, a simulation module 230 of the computing system 200 can simulate the distribution (e.g., simulate data distribution to caches and other memory components, and execution of the compute tasks on the hardware components as distributed), measure the results (e.g., bandwidth usage across hardware components, latency, memory usage, power consumption, etc.), and repeat the process any number of times. Upon completing any number of simulations, the computing system 200 can rank the distributions accordingly. It is contemplated that this ML approach may be used alone or in combination with other approaches described herein to identify weight parameters and/or ultimately achieve a most optimal fit for the software structure given the hardware topology. For example, the computing system 200 can utilize both the learning-based approach to simulate various random distributions of the software structure, and the heuristic approach to provide a most optimal compute graph and data positioning graph for the software structure.

### Example System-on-Chip

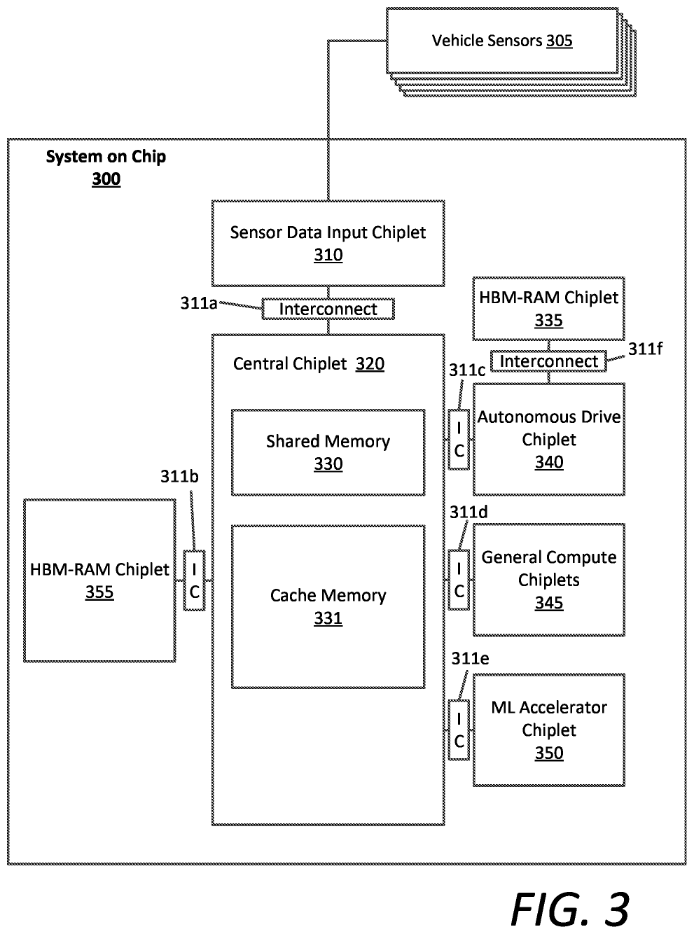

FIG. 3 is a block diagram illustrating an example SoC 300, in accordance with examples described herein. The example SoC 300 shown in FIG. 3 can include additional components, and the components of system on chip 300 may be arranged in various alternative configurations other than the example shown. Thus, the system on chip 300 of FIG. 3 is described herein as an example arrangement for illustrative purposes and is not intended to limit the scope of the present disclosure in any manner. In certain implementations, the hardware components and arrangement shown in FIG. 3, can be comprised in a given hardware topology for compute task optimization, as described throughout the present disclosure.

Referring to FIG. 3, a sensor data input chiplet 310 of the system on chip 300 can receive sensor data from various vehicle sensors 305 of the vehicle. These vehicle sensors 305 can include any combination of image sensors (e.g., single cameras, binocular cameras, fisheye lens cameras, etc.), LIDAR sensors, radar sensors, ultrasonic sensors, proximity sensors, and the like. The sensor data input chiplet 310 can automatically dump the received sensor data as it's received into a cache memory 331 of the central chiplet 320. The sensor data input chiplet 310 can also include an image signal processor (ISP) responsible for capturing, processing, and enhancing images taken from the various vehicle sensors 305. The ISP takes the raw image data and performs a series of complex image processing operations, such as color, contrast, and brightness correction, noise reduction, and image enhancement, to create a higher-quality image that is ready for further processing or analysis by the other chiplets of the SoC 300. The ISP may also include features such as auto-focus, image stabilization, and advanced scene recognition to further enhance the quality of the captured images. The ISP can then store the higher-quality images in the cache memory 331.

In some aspects, the sensor data input chiplet 310 publishes identifying information for each item of sensor data (e.g., images, point cloud maps, etc.) to a shared memory 330 of a central chiplet 320, which acts as a central mailbox for synchronizing workloads for the various chiplets. The identifying information can include details such as an address in the cache memory 331 where the data is stored, the type of sensor data, which sensor captured the data, and a timestamp of when the data was captured.

To communicate with the central chiplet 320, the sensor data input chiplet 310 transmits data through an interconnect 311a. Interconnects 311a-f each represent die-to-die (D2D) interfaces between the chiplets of the SoC 300. In some aspects, the interconnects include a high-bandwidth data path used for general data purposes to the cache memory 331 and a high-reliability data path to transmit functional safety and scheduler information to the shared memory 330. Depending on bandwidth requirements, an interconnect may include more than one die-to-die interface. For example, interconnect 311a can include two interfaces to support higher bandwidth communications between the sensor data input chiplet 310 and the central chiplet 320.

In one aspect, the interconnects 311a-f implement the Universal Chiplet Interconnect Express (UCIe) standard and communicate through an indirect mode to allow each of the chiplet host processors to access remote memory as if it were local memory. This is achieved by using a specialized Network on Chip (NoC) Network Interface Unit (NIU) (allows freedom of interferences between devices connected to the network) that provides hardware-level support for remote direct memory access (RDMA) operations. In UCIe indirect mode, the host processor sends requests to the NIU, which then accesses the remote memory and returns the data to the host processor. This approach allows for efficient and low-latency access to remote memory, which can be particularly useful in distributed computing and data-intensive applications. Additionally, UCIe indirect mode provides a high degree of flexibility, as it can be used with a wide range of different network topologies and protocols.

In various examples, the system on chip 300 can include additional chiplets that can store, alter, or otherwise process the sensor data cached by the sensor data input chiplet 310. The system on chip 300 can include an autonomous drive chiplet 340 that can perform the perception, sensor fusion, trajectory prediction, and/or other autonomous driving algorithms of the autonomous vehicle. The autonomous drive chiplet 340 can be connected to a dedicated HBM-RAM chiplet 335 in which the autonomous drive chiplet 340 can publish all status information, variables, statistical information, and/or processed sensor data as processed by the autonomous drive chiplet 340.

In various examples, the system on chip 300 can further include a machine-learning (ML) accelerator chiplet 340 that is specialized for accelerating AI workloads, such as image inferences or other sensor inferences using machine learning, in order to achieve high performance and low power consumption for these workloads. The ML accelerator chiplet 340 can include an engine designed to efficiently process graph-based data structures, which are commonly used in AI workloads, and a highly parallel processor, allowing for efficient processing of large volumes of data. The ML accelerator chiplet 340 can also include specialized hardware accelerators for common AI operations such as matrix multiplication and convolution as well as a memory hierarchy designed to optimize memory access for AI workloads, which often have complex memory access patterns.

The general compute chiplets 345 can provide general purpose computing for the system on chip 300. For example, the general compute chiplets 345 can comprise high-powered central processing units and/or graphical processing units that can support the computing tasks of the central chiplet 320, autonomous drive chiplet 340, and/or the ML accelerator chiplet 350.

In various implementations, the shared memory 330 can store programs and instructions for performing autonomous driving tasks. The shared memory 330 of the central chiplet 320 can further include a reservation table that provides the various chiplets with the information needed (e.g., sensor data items and their locations in memory) for performing their individual tasks. Further description of the shared memory 330 in the context of the dual SoC arrangements described herein is provided below with respect to FIG. 4. The central chiplet 320 also includes the large cache memory 331, which supports invalidate and flush operations for stored data.

Cache miss and evictions from the cache memory 331 are sent by a high-bandwidth memory (HBM) RAM chiplet 355 connected to the central chiplet 320. The HBM-RAM chiplet 355 can include status information, variables, statistical information, and/or sensor data for all other chiplets. In certain examples, the information stored in the HBM-RAM chiplet 355 can be stored for a predetermined period of time (e.g., ten seconds) before deleting or otherwise flushing the data. For example, when a fault occurs on the autonomous vehicle, the information stored in the HBM-RAM chiplet 355 can include all information necessary to diagnose and resolve the fault. Cache memory 331 keeps fresh data available with low latency and less power required compared to accessing data from the HBM-RAM chiplet 355.

As provided herein, the shared memory 330 can house a mailbox architecture in which a reflex program comprising a suite of instructions is used to execute workloads by the central chiplet 320, general compute chiplets 345, and/or autonomous drive chiplet 340. In certain examples, the central chiplet 320 can further execute a functional safety (FuSa) program that operates to compare and verify output of respective pipelines to ensure consistency in the ML inference operations. In still further examples, the central chiplet 320 can execute a thermal management program to ensure that the various components of the SoC 300 operates within normal temperature ranges. Further description of the shared memory 330 in the context of out-of-order workload execution in independent deterministic pipelines is provided below with respect to FIG. 3.

### Optimized Compute Task Allocation and Scheduling

FIG. 4 is a block diagram illustrating an example central chiplet 400 of an SoC arrangement for implementing workload execution in independent pipelines, in accordance with examples described herein. The central chiplet 400 shown in FIG. 4 can correspond to the central chiplet 320 of the SoC 300 as shown in FIG. 3. Furthermore, the sensor data input chiplet 410 of FIG. 4 can correspond to the sensor data input chiplet 310 shown in FIG. 3, and the workload processing chiplets 420 shown in FIG. 4, can correspond to the general compute chiplets 345, ML accelerator chiplet 350, and/or the autonomous drive chiplet 340 shown in FIG. 3.

Referring to FIG. 4, the central chiplet 400 can include a shared memory 460 storing a reflex program 430 and an application program 435. As provided herein, the reflex program 430 can comprise a set of instructions for executing reflex workloads in independent pipelines. The reflex workloads can comprise sensor data acquisition, sensor fusion, and inference tasks that facilitate scene understanding of the surrounding environment of the vehicle. These tasks can comprise two-dimensional image processing, sensor fused data processing (e.g., three-dimensional LIDAR, radar, and image fusion data), neural radiance field (NeRF) scene reconstruction, occupancy grid determination, object detection and classification, motion prediction, and other scene understanding tasks for autonomous vehicle operation.

As further provided herein, the application program 435 can comprise a set of instructions for operating the vehicle controls of the autonomous vehicle based on the output of the reflex workload pipelines. For example, the application program 435 can be executed by one or more processors 440 of the central chiplet 400 and/or one or more of the workload processing chiplets 420 (e.g., the autonomous drive chiplet 240 of FIG. 2) to dynamically generate a motion plan for the vehicle based on the execution of the reflex workloads, and operate the vehicle's controls (e.g., acceleration, braking, steering, and signaling systems) to execute the motion plan accordingly.

In various implementations, the central chiplet 400 can include a set of one or more processors 440 (e.g., a transient-resistant CPU and general compute CPUs) that can execute a scheduling program 442 for execution of workloads as runnables in independent pipelines (e.g., in accordance with the compute task and data positioning optimizations described herein). In certain examples, one or more of the processors 440 can execute reflex workloads in accordance with the reflex program 430 and/or application workloads in accordance with the application program 435. As such, the processors 440 of the central chiplet 400 can reference, monitor, and update dependency information in workload entries of the reservation table 450 as workloads become available and are executed accordingly. For example, when a workload is executed by a particular chiplet, the chiplet updates the dependency information of other workloads in the reservation table 450 to indicate that the workload has been completed. This can include changing a bitwise operator or binary value representing the workload (e.g., from 0 to 1) to indicate in the reservation table 450 that the workload has been completed. Accordingly, the dependency information for all workloads having dependency on the completed workload is updated accordingly.

In embodiments described herein, the scheduling program 442 and reservation table 450 can be configured based on the compute task and data positioning optimizations performed by the task allocation module 210 and graph generator 220 as shown and described with respect to FIG. 2. For example, based on the optimized compute graph and optimized data positioning graph—indicating where raw and processed sensor data is to be positioned and accessed, as well as which computer components are to execute the individual workloads when available (e.g., individual workload processing chiplets 420 and/or processors 440 of the central chiplet 400)—the scheduling program 442 can schedule the workload IDs in reservation table 450 for execution as runnables by configuring the dependency information, address information (e.g., cache or memory location of where to access sensor data for executing the runnable), and affinity information (e.g., the specific processing component to execute the runnable).

According to examples described herein, the reservation table 450 can include workload entries, each of which indicates a workload identifier that describes the workload to be performed, an address in the cache memory 415 and/or HBM-RAM of the location of raw or processed sensor data required for executing the workload, any dependency information corresponding to dependencies that need to be resolved prior to executing the workload, and/or affinity information specifying which hardware component is to execute the runnable when the workload is available (e.g., when all dependencies are met). In certain aspects, the dependencies can correspond to other workloads that need to be executed. Once the dependencies for a particular workload are resolved, the workload entry can be updated (e.g., by the chiplet executing the dependent workloads, or by the processors 440 of the central chiplet 400 through execution of the scheduling program 442). When no dependencies exist for a particular workload as referenced in the reservation table 450, the workload can be executed in a respective pipeline by a corresponding workload processing chiplet 420.

In various implementations, the sensor data input chiplet 410 obtains sensor data from the sensor system of the vehicle, and stores the sensor data (e.g., image data, LIDAR data, radar data, ultrasonic data, etc.) in a cache 415 of the central chiplet 400. The sensor data input chiplet 410 can generate workload entries for the reservation table 450 comprising identifiers for the sensor data (e.g., an identifier for each obtained image from various cameras of the vehicle's sensor system) and provide an address of the sensor data in the cache memory 415. An initial set of workloads be executed on the raw sensor data by the processors 440 of the central chiplet 400 and/or workload processing chiplets 420, which can update the reservation table 450 to indicate that the initial set of workloads have been completed.

As described herein, the workload processing chiplets 420 monitor the reservation table 450 to determine whether particular workloads in their respective pipelines are ready for execution. As an example, the workload processing chiplets 420 can continuously monitor the reservation table using a workload window (e.g., an instruction window for multimedia data) in which a pointer can sequentially read through each workload entry to determine whether the workloads have any unresolved dependencies. If one or more dependencies still exist in the workload entry, the pointer progresses to the next entry without the workload being executed. However, if the workload indicates that all dependencies have been resolved (e.g., all workloads upon which the particular workload depends have been executed), then the relevant workload processing chiplet 420 and/or processors 440 of the central chiplet 300 can execute the workload accordingly.

As such, the workloads are executed in an out-of-order manner where certain workloads are buffered until their dependencies are resolved. Accordingly, to facilitate out-of-order execution of workloads, the reservation table 450 comprises an out-of-order buffer that enables the workload processing chiplets 420 to execute the workloads in an order governed by the resolution of their dependencies in a deterministic manner. It is contemplated that out-of-order execution of workloads in the manner described herein can increase speed, increase power efficiency, and decrease complexity in the overall execution of the workloads.

As described herein, the workload processing chiplets 420 can execute workloads in each pipeline in a deterministic manner, such that successive workloads of the pipeline are dependent on the output of preceding workloads in the pipeline. In various implementations, the processors 440 and workload processing chiplets 420 can execute multiple independent workload pipelines in parallel, with each workload pipeline including a plurality of workloads to be executed in a deterministic manner. Each workload pipeline can provide sequential output (e.g., for other workload pipelines or for processing by the application program 435 for autonomously operating the vehicle). Through concurrent execution of the reflex workloads in deterministic pipelines, the application program 435 can autonomously operate the controls of the vehicle along a travel route.

As an illustration, the scheduling program 442 can cause the processors 440 and workload processing chiplets 420 to execute the workloads as runnables in independent pipelines. In previous implementations, each image generated by the camera system of the vehicle would be processed or inferred on as the image becomes available. The instruction set would involve acquiring the image, scheduling inference on the image by a workload processing chiplet, performing inference on the image, acquiring a second image, scheduling inference on the second image by the workload processing chiplet, and performing inference on the second image, and so on across the suite of cameras of the vehicle. By reorganizing the order in which workloads are processed, the complexity of computation is significantly reduced. Specifically, for validating an autonomous driving system that utilizes out-of-order workload execution as described herein, the number of computational combinations for verification (e.g., by a safety authority) is significantly reduced.

As provided herein, the use of the workload window and reservation table 450 referencing dependency information for workloads enables the workload processing chiplets 420 to operate more efficiently by performing out-of-order execution on the workloads. Instead of performing inference on images based on when they are available, a workload processing chiplet 420 can acquire all images from all cameras first, and then perform inference on all the images together. Accordingly, the workload processing chiplet 420 executes its workloads with significantly reduced complexity, increased speed, and reduced power requirements.

In further examples, the shared memory 460 can include a thermal management program 437 executable by the one or more processors 440 to manage the various temperatures of the SoC 200, operate cooling components, perform hardware throttling, switch to backup components (e.g., a backup SoC), and the like. In still further examples, the shared memory 460 can include a FuSa program 438 that performs functional safety tasks for the SoC 200, such as monitoring communications within the SoC (e.g., using error correction code), comparing output of different pipelines, and monitoring hardware performance of the SoC. According to examples described herein, the thermal management program 437 and FuSa program 438 can perform their respective tasks in independent pipelines.

### Multiple-System-on-Chip

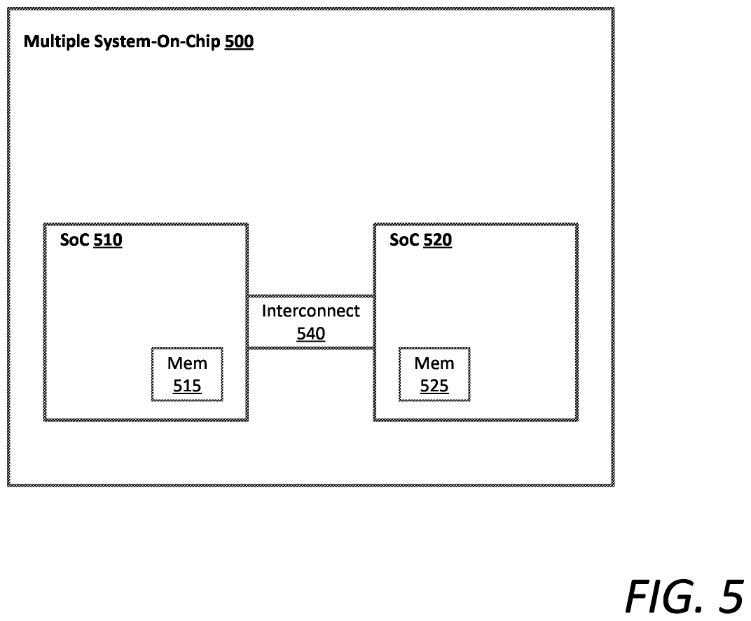

FIG. 5 is a block diagram depicting an example computing system 500 implementing a multiple system-on-chip (mSoC), in accordance with examples described herein. In various examples, the computing system 500 can include a first SoC 510 having a first memory 515 and a second SoC 520 having a second memory 525 coupled by an interconnect 540 (e.g., an ASIL-D rated interconnect) that enables each of the first SoC 510 and second SoC 520 to read each other's memories 515, 525. During any given session, the first SoC 510 and the second SoC 520 may alternate roles, between a primary SoC and a backup SoC. As provided herein, the primary SoC can perform various autonomous driving tasks, such as perception, object detection and classification, grid occupancy determination, sensor data fusion and processing, motion prediction (e.g., of dynamic external entities), motion planning, and vehicle control tasks. The backup SoC can maintain a set of computational components (e.g., CPUs, ML accelerators, and/or memory chiplets) in a low power state, and continuously or periodically read the memory of the primary SoC.

For example, if the first SoC 510 is the primary SoC and the second SoC 520 is the backup SoC, then the first SoC 510 performs a set of autonomous driving tasks and publishes state information corresponding to these tasks in the first memory 515. The second SoC 520 reads the published state information in the first memory 515 to continuously check that the first SoC 510 is operating within nominal thresholds (e.g., temperature thresholds, bandwidth and/or memory thresholds, etc.), and that the first SoC 510 is performing the set of autonomous driving tasks properly. As such, the second SoC 520 performs health monitoring and error management tasks for the first SoC 510, and takes over control of the set of autonomous driving tasks when a triggering condition is met. As provided herein, the triggering condition can correspond to a fault, failure, or other error experienced by the first SoC 510 that may affect the performance of the set of tasks by the first SoC 510.

In various implementations, the second SoC 520 can publish state information corresponding to its computational components being maintained in a standby state (e.g., a low power state in which the second SoC 520 maintains readiness to take over the set of tasks from the first SoC 510). In such examples, the first SoC 510 can monitor the state information of the second SoC 520 by continuously or periodically reading the memory 525 of the second SoC 520 to also perform health check monitoring and error management on the second SoC 520. For example, if the first SoC 510 detects a fault, failure, or other error in the second SoC 520, the first SoC 510 can trigger the second SoC 520 to perform a system reset or reboot.

In certain examples, the first SoC 510 and the second SoC 520 can each include a functional safety (FuSa) component (e.g., a FuSa program 438 executed by one or more processors 440 of a central chiplet 400, as shown and described with respect to FIG. 4) that performs the health monitoring and error management tasks. The FuSa component can be maintained in a powered state for each SoC, whether the SoC operates in a primary or backup manner. As such, the backup SoC may maintain its other components in a low powered state, with its FuSa component being powered up and performing the heath monitoring and error management tasks described herein.

In various aspects, when the first SoC 510 operates as the primary SoC, the state information published in the first memory 515 can correspond to the set of tasks being performed by the first SoC 510. For example, the first SoC 510 can publish any information corresponding to the surrounding environment of the vehicle (e.g., any external entities identified by the first SoC 510, their locations, and predicted trajectories, detected objects, such as traffic signals, signage, lane markings, and crosswalk, and the like). The state information can further include the operating temperatures of the computational components of the first SoC 510, bandwidth usage and available memory of the chiplets of the first SoC 510, and/or any faults or errors, or information indicating faults or errors in these components.

In further aspects, when the second SoC 520 operates as the backup SoC, the state information published in the second memory 525 can correspond to the state of each computational component of the second SoC 520. In particular, these components may operate in a low power state in which the components are ready to take over the set of tasks being performed by the first SoC 510. The state information can include whether the components are operating within nominal temperatures and other nominal ranges (e.g., available bandwidth, power, memory, etc.).

As described throughout the present disclosure, the first SoC 510 and the second SoC 520 can switch between operating as the primary SoC and the backup SoC (e.g., each time the system 500 is rebooted). For example, in a computing session subsequent to a session in which the first SoC 510 operated as the primary SoC and the second SoC 520 operated as the backup SoC, the second SoC 520 can assume the role of the primary SoC and the first SoC 510 can assume the role of the backup SoC. It is contemplated that this process of switching roles between the two SoCs can provide substantially even wear of the hardware components of each SoC, which can prolong the lifespan of the computing system 500 as a whole.

According to embodiments, the first SoC 510 can be powered by a first power source and the second SoC 520 can be powered by a second power source that is independent or isolated from the first power source. For example, in an electric vehicle, the first power source can comprise the battery pack used for propelling the electric motors of the vehicle, and the second power source can comprise the auxiliary power source of the vehicle (e.g., a 12-volt battery). In other implementations, the first and second power sources can comprise other types of power sources, such as dedicated batteries for each SoC 510, 520 or other power sources that are electrically isolated or otherwise not dependent from each other.

It is contemplated that the mSoC arrangement of the computing system 500 can be provided to increase the safety integrity level (e.g., ASIL rating) of the computing system 500 and the overall autonomous driving system of the vehicle. As described herein, the autonomous driving system can include any number of dual SoC arrangements, each of which can perform a set of autonomous driving tasks. In doing so, the backup SoC dynamically monitors the health of the primary SoC in accordance with a set of functional safety operations, such that when a fault, failure, or other error is detected, the backup SoC can readily power up its components and take over the set of tasks from the primary SoC.

### Methodology

FIGS. 6 and 7 are a flow charts describing example methods of optimizing compute tasks for a given hardware topology, according to examples described herein. In the below descriptions of FIGS. 6 and 7, reference may be made to reference characters representing various features as shown and described with respect to FIGS. 1 through 5. Furthermore, the methods described in connection with FIGS. 6 and 7 may be performed by a remote, backend computing system 100, 200—as described with examples of FIGS. 1 and 2—in which the given hardware topology is provided for a different computing device, such as the SoC 300 of FIG. 3 or mSoC of FIG. 5. In variations, the methods described with respect to FIGS. 6 and 7 may be performed by the computing device that will ultimately execute the compute tasks of the software structure that is to be optimized. In further variations, the methods described with respect to FIGS. 6 and 7 may be performed by a combination of backend computing systems and front-end computing systems (e.g., an on-board vehicle computing system with support from one or more backend servers). Accordingly, the “computing system” discussed in connection with FIGS. 6 and 7, may comprise a backend computing system, one or more front-end computing devices, one or more on-board vehicle computing systems, or any combination of the foregoing.

Referring to FIG. 6, at block 600, a computing system can determine a set of weighted parameters for a given computer hardware topology. As provided herein, at block 602, the set of weighted parameters can comprise latency and bandwidth parameters intrinsic in the various components of the hardware topology (e.g., latency and bandwidth values for signal paths between chiplets and/or CPU cores, caches, interconnects, network interface units (NIUs), etc.). In various examples, the set of weighted parameters can include other values and/or performance metric associated with the individual and combined components of the computer hardware topology, such as memory, power usage, computing power, unit of compute, hardware age, hardware wearing, thermal cooling requirements, individual chiplets (e.g., ML accelerator chiplets), and the like. As further provided herein, at block 604, the various components of the computer hardware topology can be included in an SoC or mSoC, such as the SoC 300 and mSoC 500 shown and described with respect to FIGS. 3 and 5.

Based on the set of weighted parameters, at block 605, the computing system can determine an optimal distribution of runnables of a compute graph on the given hardware topology. As provided herein, the compute graph can comprise any set of compute tasks based on a software structure. In one implementation, the software structure can be configured as a set of compute tasks for performing autonomous driving functions, such as perception tasks based on sensor data, object detection and classification tasks, ML inference tasks, scene understanding tasks, motion prediction of external objects, motion planning of the autonomous vehicle, and/or autonomous vehicle control tasks. These compute tasks defined in the software structure can then be made available as workloads in accordance with a scheduling program 442 (e.g., using reservation table 450 of FIG. 4) when all dependency information has been resolved or satisfied), which can then be executed as runnables (each having values for computational requirements, such as minimum values for memory and/or bandwidth). For example, the runnables can be executed by the workload processing chiplets 420 of FIG. 4, which can include any one or more of the central chiplet 320, autonomous drive chiplet 340, general compute chiplets 345, ML accelerator chiplet 350, or the HBM-RAM chiplets 335, 355 of FIG. 3.

As provided herein, at block 610, the compute task optimization can further include generating an optimal data positioning graph for execution of the runnables by specified hardware components of the hardware topology. As such, the scheduling program 442 and workload entries in the reservation table 450 can be configured in accordance with the optimized compute graph and optimized data positioning graph (e.g., to minimize latency and/or maximize data locality in executing the runnables).

In further examples, the computing system can determine the optimal schedule and distribution of the runnables corresponding to the compute graph on the hardware topology using a heuristic technique. In particular, the computing system can implement a traveling salesman algorithm using, as inputs, (i) the set of weighted parameters of the computer hardware topology, and (ii) the software structure comprised in the initial compute graph to optimize or optimally “fit” the software structure to the computer hardware topology. As an output, the traveling salesman algorithm can provide which compute tasks to assign to the individual computer components of the hardware topology. At block 615, the computing system may then configure a scheduling program 442 of the SoC 300 or each SoC 510, 520 of an mSoC arrangement to execute the compute graph in accordance with the optimal schedule and distribution of runnables and the optimized data positioning graph.

As provided herein, at block 620, the computing system can periodically reevaluate the optimal schedule and distribution of the runnables, and the positioning of data on the given hardware topology. For example, the computing system can determine an updated set of weighted parameters for the given hardware topology (e.g., due to age, wear, degradation, hardware upgrades, etc.). Additionally or alternatively, the computing system can determine an updated set of requirements of the runnables (e.g., based on software updates, changes in sensor configuration, and the like). Based on reevaluating the optimal schedule and distribution of the runnables, the computing system can determine an updated optimal distribution of the runnables and/or an updated data positioning graph for the given hardware topology, and at block 620, reconfigure the scheduling program 442 to execute the compute graph (e.g., an updated compute graph) in accordance with the updated optimal distribution and data positioning.

FIG. 7 is a flow chart describing a method of optimizing compute tasks given a computer hardware topology using a learning-based approach, in accordance with examples described herein. Referring to FIG. 7, at block 700, a computing system may implement a neural network to repeatedly distribute a software structure comprising a set of compute tasks onto a hardware topology comprising a set of computing components. For example, the neural network may be trained to determine, based solely on a hardware topology graph with no predefined weights, the optimal arrangement for executing the software structure using the hardware geometry (e.g., schedule and distribution of compute tasks on the various computer components of the hardware topology).

In certain examples, at block 705, the neural network can, for each iteration of repeatedly distributing the software structure on the hardware topology, simulate execution of the compute tasks for the iteration. For each simulation, at block 710, the neural network can further measure results or values corresponding to compute parameters, such as overall latency in the system, bandwidth usage (at block 712), and other compute parameters, such as memory usage, power consumption, heat generated, other compute units, and the like (at block 714).

In certain implementations, at block 715, the computing system can determine one or more weighted parameters for the heuristic optimization of the compute tasks, as performed by the method described with respect to FIG. 6. For example, through simulation of certain distributions of compute tasks and data positioning, the computing system can identify which parameters require increased weighting (e.g., network latency between the ML accelerator chiplet and central chiplet) and/or which parameters may be disregarded (e.g., network latency between the HBM-chiplet and central chiplet) for the optimization. In further examples, the computing system can identify compute values of individual hardware components of the given hardware topology (e.g., individual chiplets) and determine a weighting for each compute value for the heuristic optimization.

Based on repeatedly distributing the software structure on the hardware topology and simulating their executions, the neural network can determine an optimal arrangement for executing the compute tasks of the software structure on the set of computing components of the hardware topology. For example, at block 720, the neural network can rank the various software distribution simulations based on the measured results or values to determine the optimal arrangement. In doing so, the neural network can seek to minimize overall latency, bandwidth usage, power consumption, heat generation, and/or other parameters in the hardware components while effectively executing the compute tasks of the software structure.

Upon determining the optimal arrangement, at block 725, the computing system can configure the scheduling program 442 of the computer components to execute the compute graph and data positioning graph corresponding based on the optimal arrangement. As provided herein, the hardware topology can comprise an SoC 300 or mSoC 500 with each SoC comprising a central chiplet 400 and a set of workload processing chiplets 420. In such embodiments, the central chiplet 400 can include a shared memory 460 accessible by the set of workload processing chiplets 420 for executing available workloads as runnables (e.g., in a reservation table 450), and the scheduling program 442 for scheduling the runnables of the compute graph for execution by the workload processing chiplets 420 in accordance with the optimal distribution.

It is contemplated for examples described herein to extend to individual elements and concepts described herein, independently of other concepts, ideas or systems, as well as for examples to include combinations of elements recited anywhere in this application. Although examples are described in detail herein with reference to the accompanying drawings, it is to be understood that the concepts are not limited to those precise examples. As such, many modifications and variations will be apparent to practitioners skilled in this art. Accordingly, it is intended that the scope of the concepts be defined by the following claims and their equivalents. Furthermore, it is contemplated that a particular feature described either individually or as part of an example can be combined with other individually described features, or parts of other examples, even if the other features and examples make no mention of the particular feature.

What is claimed is:

1. A computing system for optimizing compute tasks, the computing system comprising:
one or more processors; and
a memory storing instructions that, when executed by the one or more processors, cause the computing system to:
determine a set of weighted parameters for a given hardware topology;
based on the set of weighted parameters, determine an optimal distribution of (i) runnables of a compute graph on the given hardware topology, and (ii) data positioning in memory components of the given hardware topology for executing the runnables; and
configure a scheduling program on the given hardware topology to execute the compute graph in accordance with the optimal distribution.

2. The computing system of claim 1, wherein determining the optimal distribution comprises executing a traveling salesman algorithm using the set of weighted parameters and a set of requirements of the runnables.

3. The computing system of claim 2, wherein the executed instructions further cause the computing system to:
reevaluate the optimal distribution of the runnables on the given hardware topology by performing at least one of (i) determining an updated set of weighted parameters for the given hardware topology, or (ii) determining an updated set of requirements of the runnables; and
based on reevaluating the optimal distribution, determine an updated optimal distribution of the runnables on the given hardware topology.

4. The computing system of claim 3, wherein the executed instructions further cause the computing system to:
reconfigure the scheduling program to execute the compute graph in accordance with the updated optimal distribution.

5. The computing system of claim 1, wherein the set of weighted parameters for the given hardware topology comprises a plurality of: latency, bandwidth, memory, power usage, computing power, unit of compute, hardware age, hardware wearing, thermal cooling, or compute values of individual components of the given hardware topology.

6. The computing system of claim 1, wherein the given hardware topology corresponds to a multiple system-on-chip (mSoC) comprising a central chiplet and a set of workload processing chiplets.

7. The computing system of claim 6, wherein the central chiplet includes (i) a shared memory accessible by the set of workload processing chiplets, and (ii) the scheduling program to schedule the runnables of the compute graph for execution by the workload processing chiplets in accordance with the optimal distribution.

8. The computing system of claim 7, wherein the shared memory stores data required for executing the runnables and has a hierarchy including a set of caches accessible over a network, and wherein the caches and the network are associated with intrinsic latencies.

9. The computing system of claim 1, wherein the computing system is included in the given hardware topology.

10. A method of optimizing compute tasks of a software structure, the method being performed by one or more processors and comprising:
implement a neural network to repeatedly distribute the software structure comprising the compute tasks onto a hardware topology comprising a set of computing components; and
based on repeatedly distributing the software structure on the hardware topology, determine an optimal arrangement for (i) data positioning in memory components of the hardware topology for executing the compute tasks, and (ii) executing the compute tasks of the software structure on the set of computing components of the hardware topology.

11. The method of claim 10, wherein the hardware topology comprises a multiple system-on-chip (mSoC) comprising a central chiplet and a set of workload processing chiplets.

12. The method of claim 11, wherein the central chiplet includes (i) a shared memory accessible by the set of workload processing chiplets, and (ii) the scheduling program to schedule the runnables of the compute graph for execution by the workload processing chiplets in accordance with the optimal distribution.

13. The method of claim 12, wherein the shared memory stores data required for executing the runnables and has a hierarchy including a set of caches accessible over a network, and wherein the set of caches and the network are associated with intrinsic latencies.

14. The method of claim 10, wherein for each iteration of repeatedly distributing the software structure on the hardware topology, the neural network simulates (i) positioning of data in the memory components of the hardware topology, and (ii) execution of the compute tasks by individual computing components of the hardware topology for the iteration.

15. The method of claim 14, wherein the neural network further measures results of simulating the positioning of data in memory components of the hardware topology, and the execution of the compute tasks for each iteration, the results corresponding to one or more of: bandwidth usage across the hardware topology, latency, memory usage, or power consumption.

16. The method of claim 10, further comprising:
executing the compute tasks of the software structure on the set of computing components of the hardware topology in accordance with the optimal arrangement.

17. A non-transitory computer readable medium storing instructions that, when executed by one or more processors of a computing system, cause the one or more processors to:
determine a set of weighted parameters for a given hardware topology;
based on the set of weighted parameters, determine an optimal distribution of (i) runnables of a compute graph on the given hardware topology, and (ii) data positioning in memory components of the given hardware topology for executing the runnables; and
configure a scheduling program on the given hardware topology to execute the compute graph in accordance with the optimal distribution.

18. The non-transitory computer readable medium of claim 17, wherein determining the optimal distribution comprises executing a traveling salesman algorithm using the set of weighted parameters and a set of requirements of the runnables.

19. The non-transitory computer readable medium of claim 18, wherein the executed instructions further cause the computing system to:
reevaluate the optimal distribution of the runnables on the given hardware topology by performing at least one of (i) determining an updated set of weighted parameters for the given hardware topology, or (ii) determining an updated set of requirements of the runnables; and
based on reevaluating the optimal distribution, determine an updated optimal distribution of the runnables on the given hardware topology.

20. The non-transitory computer readable medium of claim 19, wherein the executed instructions further cause the computing system to:
reconfigure the scheduling program to execute the compute graph in accordance with the updated optimal distribution.
